(19) United States
(12) Patent Application Publication
(10) Pub. No.: US 2009/0208609 A1
(43) Pub. Date: Aug. 20, 2009

(54) METHOD FOR PRODUCING A CRUNCHY FOOD PRODUCT

(76) Inventors: GENEVIEVE BARNARD LAWSON, Carrollton, TX (US); Dimitris Lykomitros, Dallas, TX (US); Richard Todd Smith, McKinney, TX (US)

Correspondence Address: CARSTENS & CAHOON, LLP, P O BOX 802334, DALLAS, TX, 75380, US

(21) Appl. No.: 12/033,665

(22) Filed: Feb. 19, 2008

(51) Int. Cl. A23P 1/08; A23L 1/48; A23G 3/54

(52) U.S. Cl. 426/93; 426/291; 426/89; 426/102; 426/103

(57) ABSTRACT

A food producing method used in panning for delivering enhanced nutrition benefits and for decoupling adhesion and texture and the resulting product. First a plurality of center portions are obtained and introduced into a mixer. Then primary slurry is added followed by a dry mix which adheres to said center portions. Next, a secondary slurry is prepared which provides the adhesiveness required to adhere inclusions to the center portion. The use of a secondary slurry allows the decoupling of adhesion and texture whereby a softer product is produced which does not yield a hard, glassy texture.

### BACKGROUND OF THE INVENTION

1. Technical Field

The present invention relates to a method of panning which delivers enhanced nutritional benefits to a food product. It further provides a method to allow for the decoupling of adhesion and texture in the manufacture of food products using panning.

2. Description of Related Art

Panning is the stacking of layers of one material onto another. Panning one food product with another food product is well known in the art. Typically a nut or fruit is placed in a batch tumbler and is coated with a slurry. Next a solid is introduced into the tumbler. The solid adheres to the slurry, forming a layer. Then more slurry is added followed by subsequent solids. More layers are added by repeating the process of adding slurry and then adding solids.

Today, many candy manufacturers still employ panning to produce a variety of products. For example, panning is used with hard sugar to produce jawbreakers. Further jelly beans are produced with soft sugar panning.

Panning has likewise been widely used in the nut industry. Manufacturers use panning to add coatings to nuts and fruits that deliver indulgent flavors and textures. One method of panning is hot panning which produces pralines and French nuts. Another method is chocolate panning which results in chocolate covered fruits or nuts. Finally, many manufacturers employ starch panning wherein a starch/flour mixture is used to coat the nuts. The nuts are then usually subsequently fried.

The recent trend of consumers is to focus on healthier foods. Consequently, many consumers have become very label educated and thus tend to choose snack foods which are considered “label friendly.” One trend is to select snack foods that are baked rather than fried. Likewise, another trend is to avoid foods which comprise corn syrup. Finally, another trend is to select foods which comprise whole grains and optionally inclusions such as sesame seeds and oats which offer additional nutritional value. However, many of these consumer preferences are difficult to achieve in the panning of nuts or fruits. These will be discussed in turn below.

Regarding baking, it has previously proven difficult to produce a baked product which exhibits the desired attributes. Frying is generally the preferred process as it typically offers a product with a softer crunch as compared to baking. Further, the selection of the materials used for baking has previously been limited. When baking, the materials have typically been limited to a combination of chemical leaveners and a source of amylopectin at a level of about 1% to about 40% by weight. These had been necessary to achieve the expansion which results in a light, fluffy product. The use of whole grains has traditionally been limited because of the expansion loss associated with high levels of fibers. Thus, because of the reduced expansion, any product produced with ingredients high in fiber was typically very hard.

Regarding corn syrup, corn syrup has typically been widely used because of its flexibility as an ingredient. Corn syrup of varying Dextrose Equivalent (DE) is commercially available. DE is a measure of the reducing power of a substance relative to dextrose calculated on a dry weight basis. Thus, the DE of pure dextrose is 100. Low conversion corn syrup can be as low or lower than about 36 DE, medium conversion corn syrup is typically about 42 DE, and high conversion corn syrup can be as high or higher than about 62 DE. Taken further, high fructose corn syrup typically has a DE of about 97. The stickiness, hardness, and sweetness of a product are all a function of the DE. Thus, using corn syrup of varying DE can be used to produce a product with the desired hardness, stickiness, and sweetness. Because of its great flexibility, corn syrup has been used in virtually every nut panning process. As stated above, however, many consumers are trying to avoid products which comprise corn syrup.

Regarding inclusions, a product with inclusions has proven difficult to produce using the panning process. One reason for this is that the slurry adhesive properties are coupled with the finished product texture; as the adhesiveness of a slurry is adjusted, so too is the texture of the final product. For example, in starch panning, a sugar slurry is generally used to adhere a flour mix to a nut center. The saccharide composition of the slurry determines both the texture of the finished product as well as the adhesiveness of the slurry. Slurries which are highly adhesive and can facilitate the formation of both a multitude of flour/sugar layers as well as a layer of inclusions are generally high in short chain saccharides, something that inadvertently yields a hard glassy texture. A glassy texture is a smooth glass-like texture which resembles the coating of M&M's® Candy by Mars Incorporated located in McLean, Va., which in many applications is undesirable. Another effect of short chain saccharides is that it tends to cause the product to be much sweeter compared to long chain saccharides. While a slurry can be produced which will form layers and adhere to inclusions, the product produced from the slurry is undesirably hard. Finally, while the addition of such inclusions increases the nutrition content of the product, it likewise increases the hardness of the product as it offers a harder outer layer. This problem can be exaggerated if the product is later baked.

Consequently, it is desirable to have a coated food product which can comprise additional inclusions. Further, it is desirable that such a coated food product be baked rather than fried. Still further, it is desirable to produce a finished product which comprises inclusions and is baked but is not undesirably hard. Finally, it is desirable to produce a label friendly snack wherein corn syrup is not used.

### SUMMARY OF THE INVENTION

A method of panning is provided which produces a crunchy food product. The finished product comprises a center portion coated with at least one layer of dry mix and further coated with a layer of inclusions. The center portion comprises nuts, seeds, fruits, or vegetables. The mix is typically flour based and can comprise a variety of ingredients, including high fiber ingredients. The inclusions can comprise nuts, oats, seeds, fruit, etc., and allow another opportunity to further increase the nutritional content of the food product.

As to one embodiment, two slurries are used. A primary slurry provides sufficient adhesiveness to adhere a dry mix onto a center portion. The composition of the primary slurry is adjusted to provide for desired product qualities. A secondary slurry is used to adhere inclusions to the center portions. When inclusions are desired, the secondary slurry typically has greater adhesive qualities than the primary slurry as the slurry must be sufficiently adhesive to adhere inclusions. Because adhesiveness can be achieved primarily by the secondary slurry, the primary slurry can be adjusted to achieve other product qualities such as texture and taste. Thus, the use of a second slurry decouples the relationship of texture and adhesiveness providing increased flexibility in the manufacturing process.

As to other embodiments, slurries which comprise binders other than corn syrup can be used. Ingredients such as honey, brown sugar, and rice syrup can be used in lieu of corn syrup. This provides for a more label friendly product.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawing, wherein:

FIG. 1 depicts a process diagram of one embodiment of the current invention.

### DETAILED DESCRIPTION

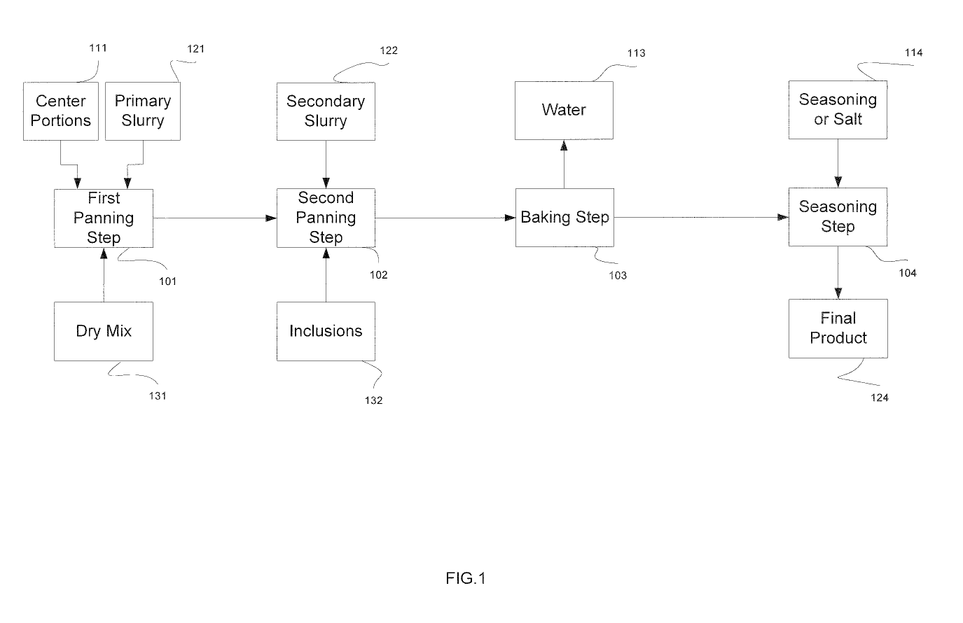

Several embodiments of Applicants' invention will now be described with reference to FIG. 1. Unless stated otherwise, all percentages are deemed to be weight percentages.

FIG. 1 depicts a process diagram of one embodiment of the current invention. While FIG. 1 will be discussed as a batch operation, the method disclosed can successfully be performed with a semi-batch or continuous operation as well. The middle horizontal section of FIG. 1 refers to the four processing steps and includes the first panning step 101, the second panning step 102, the baking step 103, and the seasoning step 104. Thus, moving from left to right on FIG. 1 follows the processing of the food product from the first step of panning 101 through the final seasoning step 104. The addition of or removal of an ingredient is shown with vertical arrows. Thus, as shown in the first panning step 101, primary slurry 121, center portion 111, and dry mix 131 are all added during the first panning step. Each of the processing steps and each of the ingredients will be discussed in detail below. It should again be noted that FIG. 1 shows only one embodiment of the current invention. Various steps and ingredients may be inserted or removed from the illustrated embodiment which are still within the scope of the current invention.

FIG. 1 begins with the first panning step 101. The first ingredient added to the first panning step 101 is the center portion 111. As used herein a “center portion” refers to a food product such as a nut, seed, candy, or intermediate to low moisture fruits or vegetables. As used herein “intermediate to low moisture” means a moisture content of less than about 20% by weight. Suitable nuts can comprise almonds, Brazil nuts, cashews, dried chick peas, Macadamia nuts, peanuts, pecans, pistachios, walnuts, and others. An example of a seed which can be used in the invention is a sunflower seed kernel. While the invention works on virtually any type of food product, because panning is used, in a preferred embodiment the food is fairly round so that it easily tumbles. The center portion 111 is cleaned, shelled, de-pitted, etc. as necessary depending on the food used; the center portion 111 is prepared as if it were going to be eaten raw. Additionally, the center portions 111 may be optionally coated with a preservative or other treating agent which may serve to prolong the shelf life. One such example includes coating the center portion with a film forming ingredient to prevent moisture or oil migration from the center portion to the coating. Suitable film forming ingredients include, but are not limited to, wax, protein, or hydrocolloids such as gum arabic. By preventing moisture or oil from migrating from the center portion, the shelf life of the final product is increased. Other agents such as antimicrobial agents may also be utilized.

Center portions 111 may be of virtually any size. Typically the finished product 124 ranges from about ½ of an inch in diameter to about 3 inches in diameter, though other diameters are feasible. Accordingly, the center portion 111 typically comprises a diameter of about ¼ of an inch to about 2 inches in diameter.

The center portions 111 are added, at virtually any temperature, to a mixer, In some embodiments it may be desirable to add the center portions 111 at an elevated temperature, but in many embodiments the center portions 111 are added at whatever temperature they are stored. As used herein, a “mixer” is any equipment which is capable of panning or coating one food product with another. In one embodiment, the mixer comprises an engrossing tumbler. As used herein, “engrossing” is the same as panning. An engrossing tumbler, as referred above, is similar in operation to a cement mixer. In one embodiment, the tumbler mixes its contents as it rotates on an axis angled at about 15°. Thus, the contents in the bottom back of the tumbler will get pushed to the top front of the tumbler, following the path of a “figure 8.” Typical tumblers handle batches ranging from about 150 pounds to about 220 pounds, but larger or smaller tumblers may also be utilized. The tumblers optionally have heating or cooling capabilities, although in a preferred embodiment the tumblers are at atmospheric pressure and do not have any additional heat provided or removed. While the mixer has been described as a tumbler, the description should not be deemed limiting as many other mixing means known in the art can be successfully employed.

The next ingredient employed in the first panning step 101 is the primary slurry 121. As to one embodiment, a primary slurry 121 comprising a binder is used. As used herein a “binder” is a binding agent which is sufficiently sticky to adhere two solids together. Although many different binders may be successfully employed, in one embodiment, the primary slurry 121 comprises at least one binder selected from the following group: honey, brown sugar, rice syrup, and corn syrup. In a preferred embodiment, the primary slurry 121 comprises water, honey, brown sugar, rice syrup, and sea salt. As discussed above, many consumers strive to avoid products comprising corn syrup, especially high fructose corn syrup. Accordingly, in one embodiment the binder comprises corn syrup in an amount less than about 5% by weight of the slurry. In a preferred embodiment, the primary slurry 121 comprises no corn syrup. In such embodiments, one novel aspect of the current invention is the use of ingredients other than corn syrup to achieve desired attributes in a final product. As discussed above, the composition of the slurry determines both the texture of the finished product as well as the adhesiveness of the product.

As will be discussed below, to overcome the problem of texture being coupled with adhesiveness, the current invention utilizes a secondary slurry 122 to provide the adhesiveness needed to adhere pieces of inclusions. This allows for increased freedom in selecting the primary slurry 121 to account for other attributes such as taste, sweetness, and texture. Thus, the use of a secondary slurry 122 allows for the decoupling of texture and adhesiveness. One benefit of this decoupling is the formation of a primary slurry 121 which can produce a softer intermediate product. A softer intermediate product may be desirable or necessary if subsequent processing hardens the intermediate product to an undesirable degree. For example, the addition of inclusions 132 to the intermediate product often results in a harder final product. Likewise, baking 103 typically results in a harder final product. It can be appreciated that if it is known that subsequent processing steps will result in a harder process then it will prove helpful to produce a primary slurry which can produce a softer intermediate product.

The sweetness, the softness, and the stickiness of a product are a function of the dextrose equivalent (DE) of its slurry. As the DE is increased, the sweetness and stickiness of the product increases, whereas the softness of the product decreases. It should be noted that a high DE comprises a short saccharide length whereas a low DE comprises a long saccharide length. It can be appreciated that on the spectrum of DE, on one extreme side is a product with a high DE which is sweet, sticky, and hard, and on the other extreme side is a product with a low DE which is not very sweet or sticky, but which is very soft. Thus, for slurry formulation the first step is determining where on that spectrum is it desirable to operate. As stated above, if it is known that subsequent processing includes baking 103 and or the addition of inclusions 132, then it is desirable for the intermediate product to be softer. These product qualities are adjusted by varying the composition of the primary slurry 121.

As discussed above, in one embodiment the primary slurry 121 comprises brown sugar, honey, rice syrup, salt, and water. Brown sugar typically comprises a medium DE, between about 40 and about 60. Brown sugar is a sucrose sugar which typically comprises molasses. As used in one preferred embodiment, brown sugar comprises from about 0% to about 60% of the primary slurry 121, more preferably from about 5% to about 25%. Honey has a higher DE than brown sugar, typically between about 90 and about 99. “Honey,” as used herein, refers to a sweet and viscous fluid produced by bees and derived from the nectar of flowers. In one preferred embodiment, honey comprises from about 0% to about 25% of the primary slurry 121, more preferably from about 5% to about 25%. Rice syrup has a lower DE than honey, typically ranging from about 20 to about 40. As used herein “rice syrup” is a sweetener derived from culturing cooked rice. In one preferred embodiment, rice syrup comprises from about 0% to about 70% of the primary slurry 121, more preferably from about 20% to about 50%. The primary slurry 121 can also comprise water. The water content of a slurry is adjusted to adjust the viscosity of the slurry as well as other factors. The composition of water in the primary slurry 121 in one embodiment ranges from about 0% to about 60%, more preferably from about 20% to about 40%. Finally, the primary slurry 121 may comprise salt. Salt is added primarily for taste. In one embodiment, salt ranges from about 0% to about 5% of the primary slurry 121. The composition of each ingredient is adjusted to produce a slurry with a desired DE and thus a desired texture, stickiness, and sweetness. Additionally, the composition of each ingredient is adjusted for taste and flavor as well.

Table 1, below, summarizes compositions of the primary slurry 121 for one preferred embodiment.

TABLE 1
Primary Slurry Composition

| Ingredient | Composition |
|---|---|
| Rice Syrup | 39% |
| Water | 30% |
| Brown Sugar | 17% |
| Honey | 12% |
| Salt | 2.0% |
| Total | 100% |

The primary slurry 121 as disclosed in Table 1 results in a final product 124 which, after the addition of inclusions 132, and after baking 103, is crunchy yet not undesirably hard.

Once a primary slurry 121 composition has been selected, and formulated, it is heated to a temperature of about 150° F. to about 170° F. The primary purpose for so heating the primary slurry 121 is to ensure the ingredients are dissolved and are microbiologically safe; these temperatures make the slurry microbiologically stable. Further, raising the temperature results in decreased viscosity which is desirable as the primary slurry 121 is to be used to adhere a dry mix 131 to the center portions 111.

The next ingredient used in the first panning step 101 is the dry mix 131. The dry mix 131 comprises a variety of ingredients. This invention is ideally suited for dry mixes 131 which are starch based although other mixes work as well. In some preferred embodiments the dry mix 131 includes but is not limited to flour, sugar, waxy starch, corn bran, modified corn starch, salt, and baking powder. The dry mix 131 can optionally include specialty ingredients such as fruit powders, probiotics, beta-glucans, antioxidants and other phytochemicals, which further enhance the nutritional qualities of the product. As discussed above, when baking the dry mix 131 had typically been limited to a combination of chemical leaveners and a source of amylopectin at a level of about 1% to about 40% by weight as these were used to achieve the desired expansion to result in a light, fluffy product. The use of ingredients high in fiber had been limited in the prior art because of the expansion loss associated with high levels of fibers. With the advent of new starch processing technologies, however, chemically or physically modified starches are now available that can compensate for the aforementioned expansion loss. Consequently, it is now possible that the dry mix 131 can comprise a significant amount of whole grains without compromising texture. This allows for “made with whole grains” or “multigrain” claims that further appeal to the label-savvy consumer. “Whole grain,” as used herein, refers to grains containing all of the essential and naturally-occurring nutrients of the entire grain including, for example, the germ, bran, and endosperm fractions. “Multigrain,” as used herein, refers to a mixture of grains comprising more than two types of grain. Thus, due to advancements in the processing of starch as well as the disclosure of the instant invention, the dry mix 131 can comprise a wide variety of ingredients. Each ingredient is adjusted to alter the final product qualities such as taste, texture, etc. Table 2 below summarizes a preferred composition of one whole grain formulation of the dry mix 131. Table 3 summarizes a preferred composition of one multigrain formulation of the dry mix 131.

TABLE 2
Whole Grain Formula

| | Percentage |
|---|---|
| Ingredient | by Weight |
| Whole wheat flour | 6.0% |
| Oat Flour | 13% |
| Sugar | 14% |
| Waxy Starch | 30% |
| Corn Bran | 15% |
| Buckwheat Flour | 13% |
| Modified Corn | 9.0% |
| Starch | |
| TOTAL | 100.00% |

TABLE 3
Multigrain Formula

| | Percentage |
|---|---|
| Ingredient | by Weight |
| Whole corn flour | 42% |
| Whole Wheat Flour | 20% |
| Rice Flour | 15% |
| Whole Oat Flour | 12% |
| Sugar | 7.6% |
| Salt | 1.9% |
| Baking powder | 1.5% |
| TOTAL | 100.00% |

After a formulation for the dry mix 131 has been selected, all ingredients are milled to achieve a uniform particle size. In one embodiment the particles are milled to a size of about 60 mesh or smaller. Typically a smaller uniform particle size is preferred during the panning process as smaller particle sizes helps achieve a uniform coating.

Now that center portions 111, primary slurry 121, and a dry mix 131 have been prepared, the first panning step 101 begins. First, a volume of primary slurry 121 is fed into the tumblers. The slurry can be introduced in a variety of ways. In one embodiment the primary slurry 121 is simply poured or pumped into the tumbler; in another embodiment the primary slurry 121 is sprayed. The volume of slurry 121 added depends on the size of the vessel, the desired batch size in a tumbler, the ratio of slurry 121 to dry mix 131, the number of layers desired, as well as other factors.

The tumbler mixes the contents until the primary slurry 121 has completely coated the center portion 111. As used herein, “complete coating” means coating of at least about 80% of the available surface area. The time necessary to reach complete coating is dependent on several factors such as product geometry, adhesiveness of the slurry, application method, as well as others. In one embodiment the time necessary to achieve complete coating ranges from about 30 seconds to about 10 minutes. The volume of slurry 121 added is also dependent on the number of cycles desired. A single cycle is defined herein as the addition of a slurry followed by the addition of a solid ingredient. The number of cycles is related to, among other factors, the desired amount and thickness of the layers. For example, if it is desired that a nut be coated with a thin layer, then only a few cycles are employed. In a preferred embodiment the number of cycles ranges from about 1 to about 25, more preferably from about 5 to about 15, and most preferably about 10.

After a volume of slurry 121 has been added to the tumbler, then a volume of dry mix 131 is added to the tumbler. The dry mix 131, like the slurry 121, can be added in a variety of ways including being pumped or dropped into the tumbler. The volume of dry mix 131 is dependent on the desired number of layers and the desired thickness of each layer as well as the volume of slurry added. The dry mix 131 and primary slurry 121 are added in such a manner that sufficient slurry 121 is present to adhere the dry mix 131 onto the center portion 111. This ratio is dependent on a plurality of factors and can be streamlined through trial and error or through calculations. Typically slightly more dry mix 131 is added, by weight, than the primary slurry 121. In one embodiment the dry mix 131 accounts for about 15% to about 35% of the product before baking or frying. The amount of dry mix can be adjusted to achieve the desired taste and texture of the final product. The slurry, in one embodiment, accounts for about 10% to about 25% of the product before baking or frying. Again, these percentages vary based on a plurality of factors including slurry 121 and dry mix 131 formulation. As stated above, the adhesiveness of the primary slurry 121 is adjusted by varying the primary slurry ingredients which in turn affects the ratio of slurry 121 to dry mix 131 necessary to achieve complete coating.

After a volume of dry mix 131 is added to the tumbler then the tumbler's contents are mixed. The contents are mixed for a time sufficient to allow complete coating of the center portion 111 with the dry mix 131 and the primary slurry 121. The time necessary to allow complete coating again depends on a multitude of factors and ranges from about 1 to about 10 minutes for one layer. After mixing to complete coating, a first cycle is completed. Typically, at least one cycle is completed creating at least one layer. If so desired a new cycle is started with the addition of a second volume of primary slurry 121 and a second volume of dry mix 131 in alternate fashions to create a second layer. After the final cycle has been completed a first intermediate product is formed and the first panning step 101 is completed. The layers formed during the first panning step 101 are collectively referred to as the inner layer.

In a preferred embodiment the final product 124 comprises inclusions 132. Referring to FIG. 1, the second panning step 102 is used to adhere inclusions 132 to a first intermediate product. The first ingredient of the second panning step 102 is the secondary slurry 122. It is desirable that any inclusions 132 added to a product remain on the product to prevent waste and to increase product integrity. To ensure the inclusions 132 remain on the product, the secondary slurry 122 which adheres the inclusions 132 to the product must be highly adhesive. As used herein, “highly adhesive” refers to a slurry which is capable of adhering inclusions to at least about 80% of the surface of the center portion. As previously discussed, however, using slurries which are highly adhesive tends to create a glass-like texture which is very hard. As discussed, since this quality is undesirable, Applicants' disclose the use of two slurries, a primary and a secondary, only one of which is necessarily sufficiently adhesive to adhere the inclusions. In one embodiment, Applicants' disclose using only as much of the secondary slurry 122 as is necessary to adhere the inclusions 132, eliminating the undesirable glassy texture which results when a highly adhesive slurry is used throughout the panning process.

It follows that the secondary slurry 122 is typically more adhesive, and thus has a higher DE. The adhesiveness desired for the secondary slurry 122 is a function of many factors including the size of the inclusions and the geometry and size of the center portion 111. It can be appreciated the adhesiveness of the secondary slurry 122 does not need to be as great when the inclusions 132 are small and light compared to when heavier and larger inclusions 132 are used. Similarly, a larger center portion 111 generally offers more “flat” space compared to a smaller center portion 111 which is beneficial when attempting to adhere inclusions to the surface of a center portion 111, Accordingly, the adhesiveness of a secondary slurry 122 can be decreased if a flatter center portion 111 is used.

The secondary slurry 122, like the primary slurry 121, comprises a binder. In one embodiment, the secondary slurry 122 comprises at least one binder selected from the following group: honey, brown sugar, rice syrup, and corn syrup. The use of similar ingredients provides flexibility in processing in that storage and handling equipment for these ingredients can be used in the processing of both slurries. The use of each ingredient is adjusted to achieve desired qualities in both the slurry and the final product. It should be noted that since the secondary slurry 122 is not mixed or buried with the dry mix 131, often the ingredients of the secondary slurry 122 exhibit a stronger flavor in the final product 124 than do the ingredients of the primary slurry 121. In a preferred embodiment, the secondary slurry 122 comprises water, brown sugar, and sea salt. As previously discussed, many consumers strive to either avoid products comprising corn syrup or consume products with limited corn syrup. Accordingly, in one embodiment the binder of the secondary slurry 122 comprises corn syrup in an amount of less than about 5% by weight of the slurry. In a preferred embodiment, the secondary slurry 122 comprises no corn syrup. The secondary slurry 122 can comprise ingredients with similar ranges as those described for the primary slurry 121. Table 4 summarizes the composition of a secondary slurry 122 in one preferred embodiment.

TABLE 4
Secondary Slurry Formulation

| | Percentage |
|---|---|
| Ingredient | by Weight |
| Brown Sugar | 60% |
| Water | 38% |
| Salt | 2.0% |
| Total | 100% |

The secondary slurry 122 is mixed and heated at a temperature of about 150° F. to about 170° F. As with the primary slurry 121, the main purpose of so heating the secondary slurry 122 is to ensure the ingredients are dissolved and are microbiologically safe. Also, the elevated temperature results in a decreased viscosity, making the slurry easier to pour. Like the primary slurry 121, the secondary slurry 122 can be pumped, poured, or sprayed onto the first intermediate product. The tumbler's contents are then mixed for a time sufficient to reach complete coating. In one embodiment, the time necessary to achieve complete coating ranges from about 30 seconds to about 10 minutes. The layer or layers of secondary slurry 122 coated onto the first intermediate product are collectively referred to as the outer layer. Because the secondary slurry 122 is added after the primary slurry 121, the outer layer is adhered atop the inner layer.

After the first intermediate product is coated with a second slurry 122, the next step in the second panning step 102 is the introduction of inclusions 132. Inclusions 132 can comprise many different ingredients such as whole wheat, wheat bran, herbs, spices, sesame seeds, granola, bumped oats, chopped nuts, poppy seeds, various other seeds, fruit pieces, etc. The inclusions 132 may increase the nutritional content of the product increasing the appeal from some consumers. Further, similar to the dry mix 131, the inclusions 132 can optionally include specialty ingredients such as fruit powders, probiotics, beta-glucans, antioxidants and other phytochemicals, which further enhance the nutritional qualities of the product. Finally, the inclusions 132 can vary in size depending on the desired final product. For example, the inclusion 132 may be whole sesame seeds or may be chopped nuts milled to a fine particle size. As described above, often the slurry used to adhere the inclusions 132 to a product results in an undesirably hard product. This problem is exaggerated as the inclusions 132 likewise tend to make the texture harder. Thus, the use of inclusions 132 makes the disclosed method of using two slurries even more pertinent.

The inclusions 132 are added after the secondary slurry 122 and are thus located atop the outer layer. When more than one layer of inclusions is desired then multiple cycles of secondary slurry 122 followed by inclusions 132 are used. As to one embodiment, sufficient inclusions 132 and secondary slurry 122 are added to partially coat the first intermediate product with the inclusions 132. As used herein “sufficient” refers to an amount of an ingredient which results in the desirable attributes such as taste, texture, and coverage, yet which does not unnecessarily waste ingredients. As used herein “partially coating” means at least 5% of the available surface area is coated with the inclusions 132. In a preferred embodiment, inclusions 132 are partially coated to comprise greater than about 50% of the available surface area, while in a more preferred embodiment the inclusions 132 comprise about 80% of the available surface area. While in many embodiments it is usually preferred that the final product comprise only one layer of inclusions 132, it is possible that subsequent cycles of secondary slurry 122 and inclusions 132 may be added to produce a product with multiple layers of inclusions 132.

The tumbler's contents are allowed to mix until the first intermediate product is partially coated with inclusions 132, at which time a second intermediate is formed and the second panning step 102 is complete. In one embodiment the time necessary to achieve partial coating ranges from about 1 to about 20 minutes. Thus, in one embodiment the time from the first addition of the primary slurry 121 until a second intermediate is formed and the second panning step 102 is complete ranges from about 45 minutes to about 2 hours, more preferably between about 1 hour and 1.5 hours.

After the second intermediate product is formed, a variety of subsequent steps are possible. In one embodiment, the product is then applied a final finish. The final finish can comprise frying, baking, and the like. FIG. 1 illustrates a preferred embodiment wherein the next step is baking 103. In a preferred embodiment the second intermediate product is baked to a temperature of about 250° F. to about 350° F. and more preferably from about 285° to about 310° F. It is baked for a period of time ranging from about 15 minutes to about one hour, more preferably from about 25 minutes to about 45 minutes. The second intermediate product, upon baking, results in a loss of water 113 and accordingly a reduction of moisture content. During and after baking 103, the second intermediate product typically loses about 5% to about 25% by weight water, more preferably about 15% by weight water. In a preferred embodiment, the final product has a moisture content between about 0.5% and about 4%, and more preferably from about 1.5% to about 3%.

As shown by FIG. 1, after the baking step 103 is complete, the final step is the seasoning step 104. The second intermediate product can be seasoned with salt or seasoning 114 to form a final product 124. As used herein, “seasoning” refers to a substance used to impart flavor into a product. Examples of seasoning 114 include, but are not limited to, cinnamon, sugar, honey, cheese seasoning, garlic, etc. The amount of seasoning and salt 114 can be adjusted for taste and can take place before or after baking 103. In one embodiment about 1.1% by weight salt is added to the second intermediate product. In other embodiments about 3% by weight seasoning is added to the second intermediate product. These amounts are given as examples only and should not be deemed limiting. The amount of salt or seasoning 114, or any combination thereof is virtually limitless. The seasoning or salt 114 can applied in any desirable manner known in the art. One such example is by spraying the salt or seasoning 114 onto the second intermediate product with about a 2% by weight oil spray which helps adhere the seasoning to the product. The seasoning and salt 114 can be cascaded onto the product, or the addition can take place in a tumbler. Thereafter, a final product 124 is formed which comprises seasoning 114 atop the outer layer. It should be noted that not all steps are required in every embodiment. For example, in one embodiment, the second intermediate product is not baked. In such an embodiment, the second intermediate product formed after the completion of the second panning step 102 and an optional seasoning step 104 is the final product. Thus, while one embodiment has been described, those skilled in the art will appreciate that the order of and types of processing steps can be adjusted to yield desired products without deviating from the scope of the current invention.

The aforementioned method results in a crunchy food product. When finished, the product, in one embodiment, comprises a center portion, an inner layer adhered to the center portion, an outer layer adhered to the inner layer, and inclusions located atop the outer layer. While the invention has been particularly shown and described with reference to a preferred embodiment, it will be understood by those skilled in the art that various changes in form and detail may be made therein without departing from the spirit and scope of the invention.

What is claimed is:

1. A method for producing a food product comprising the following steps:
a) preparing a primary slurry and a secondary slurry, wherein both of said slurries comprise a binder;
b) coating center portions with an amount of primary slurry followed by an amount of dry mix in alternate fashions creating at least one layer to form a first intermediate product;
c) coating said first intermediate product with an amount of secondary slurry followed by an amount of inclusions to form a second intermediate product;
wherein said secondary slurry is more adhesive than said primary slurry.

2. The method of claim 1 further comprising the step of:
d) baking said second intermediate product.

3. The method of claim 2 wherein said baking of step d) comprises baking at temperatures from about 250° F. to about 350° F.

4. The method of claim 2 wherein said baking of step d) comprises baking for a time sufficient to produce a food product comprising a moisture content of about 0.5% to about 4%.

5. The method of claim 1 further comprising the step of:
d) seasoning said second intermediate product.

6. The method of claim 1 wherein said coating of step b) comprises introducing center portions into a tumbler.

7. The method of claim 1 wherein said coating of step b) comprises coating with center portions comprising at least one ingredient selected from the group consisting of: nuts, legumes, seeds, candy, fruits, and vegetables.

8. The method of claim 1 wherein said coating of step b) comprises coating with center portions comprising a moisture content of less than about 20% by weight.

9. The method of claim 1 wherein said preparing of step a) comprises preparing a primary slurry wherein said binder of said primary slurry comprises at least one ingredient selected from the group consisting of: honey, rice syrup, brown sugar, and corn syrup.

10. The method of claim 1 wherein said preparing of step a) comprises preparing a primary slurry comprising brown sugar in the amount of about 0% to about 60% by weight.

11. The method of claim 1 wherein said preparing of step a) comprises preparing a primary slurry comprising honey in the amount of about 0% to about 35% by weight.

12. The method of claim 1 wherein said preparing of step a) comprises preparing a primary slurry comprising rice syrup in the amount of about 0% to about 70% by weight.

13. The method of claim 1 wherein said preparing of step a) comprises preparing a primary slurry comprising water and salt.

14. The method of claim 1 wherein said coating of step b) comprises spraying said primary slurry.

15. The method of claim 1 wherein said coating of step b) comprises coating with a dry mix comprising sugar and whole grain.

16. The method of claim 1 wherein said coating of step b) comprises coating with a dry mix comprising more than two grains.

17. The method of claim 1 wherein said coating of step b) comprises coating with a dry mix which is starch based.

18. The method of claim 1 wherein said coating of step b) comprises coating with an amount of dry mix so that said second intermediate product comprises about 15% to about 35% by weight dry mix.

19. The method of claim 1 wherein said coating of step b) comprises coating with an amount of slurry so that said second intermediate product comprises about 10% to about 25% by weight primary slurry.

20. The method of claim 1 wherein said coating of step c) comprises partially coating said second intermediate product with inclusions.

21. The method of claim 1 wherein said coating of step c) comprises coating with inclusions comprising at least one ingredient selected from the group consisting of: whole wheat, whole bran, sesame seeds, poppy seeds, granola, bumped oats, chopped nuts, herbs, spices, seeds, fruits.

22. The method of claim 1 wherein said preparing of step a) comprises preparing a secondary slurry wherein said binder of said secondary slurry comprises at least one ingredient selected from the group consisting of: honey, rice syrup, brown sugar, and corn syrup.

23. The method of claim 1 wherein said preparing of step a) comprises preparing a secondary slurry wherein said secondary slurry comprises salt.

24. The method of claim 1 wherein said preparing of step a) comprises preparing a secondary slurry wherein said secondary slurry comprises brown sugar in the amount of about 0% to about 70% by weight.

25. The method of claim 1 wherein said preparing of step a) comprises preparing a primary slurry which comprises less than about 5% corn syrup.

26. The method of claim 1 wherein said preparing of step a) comprises preparing a primary slurry which does not contain corn syrup.

27. The method of claim 1 wherein said preparing of step a) comprises preparing a secondary slurry which comprises less than about 5% corn syrup.

28. The method of claim 1 wherein said preparing of step a) comprises preparing a secondary slurry which does not contain corn syrup.

29. A food product formed by the method of claim 1.

30. A crunchy food product comprising:
a center portion;
an inner layer adhered to said center portion, said inner layer comprising a primary slurry and a dry mix;
an outer layer adhered to said inner layer, said outer layer comprising a secondary slurry, wherein said secondary slurry is more adhesive than said primary slurry; and
inclusions located atop said outer layer, wherein said inclusions partially coat said outer layer.

31. The crunchy food product of claim 30 wherein neither said primary slurry nor said secondary slurry contain corn syrup.

32. The crunchy food product of claim 30 wherein said center portions comprise at least one ingredient selected from the group consisting of: nuts, legumes, seeds, candy, fruits, and vegetables.

33. The crunchy food product of claim 30 wherein said center portions comprise a moisture content of less than about 20% by weight.

34. The crunchy food product of claim 30 further comprising seasoning located atop said outer layer.

35. The crunchy food product of claim 30 wherein said inclusions comprise at least one ingredient selected from the group consisting of: whole wheat, whole bran, sesame seeds, poppy seeds, granola, bumped oats, chopped nuts, herbs, spices, seeds, fruits.

36. The crunchy food product of claim 30 wherein said dry mix of said inner layer comprises whole grains.

37. The crunchy food product of claim 30 wherein said dry mix of said inner layer comprises more than two grains.

38. The crunchy food product of claim 30 wherein said dry mix of said inner layer is flour based.

39. The crunchy food product of claim 30 wherein said crunchy food product comprises about 15% to about 35% by weight dry mix.

40. The crunchy food product of claim 30 wherein said food product has a moisture content between about 1.5% and about 4%.

41. The crunchy food product of claim 30 wherein said primary slurry comprises at least one ingredient selected from the group consisting of: honey, rice syrup, and brown sugar.

42. The crunchy food product of claim 30 wherein said primary slurry comprises salt.

43. The crunchy food product of claim 30 wherein said secondary slurry comprises at least one ingredient selected from the group consisting of: honey, rice syrup, and brown sugar.

44. The crunchy food product of claim 30 wherein said secondary slurry comprises salt.
